(19) United States
(12) Patent Application Publication
(10) Pub. No.: US 2013/0160050 A1
(43) Pub. Date: Jun. 20, 2013

(54) METHOD FOR SIMPLIFYING HOME ENTERTAINMENT SYSTEM CONFIGURATION THAT EMPLOYS BIDIRECTIONAL DIGITAL AUDIO/VIDEO INTERCONNECTIONS

(71) Applicant: Joseph F. Halgas, JR., Huntingdon Valley, PA (US)

(72) Inventor: Joseph F. Halgas, JR., Huntingdon Valley, PA (US)

(73) Assignee: GENERAL INSTRUMENT CORPORATION, Horsham, PA (US)

(21) Appl. No.: 13/326,308

(22) Filed: Dec. 14, 2011

(51) Int. Cl. H04N 21/00

(52) U.S. Cl. 725/34

(57) ABSTRACT

A method and computing device for configuring devices connected to a home entertainment network by bidirectional audio/video interconnections. The method selects a profile for a user of a home entertainment network that includes a display device connected to audio/video source devices where the connection to each audio/video source device is a bidirectional audio/video connection, and where the display device includes a preferences manager. The method determines audio/video preferences for the user of the home entertainment network, where the audio/video preferences are based on a user-selected configuration of the preferences manager. The method sends the audio/video preferences to each audio/video source device for configuring each audio/video source device based on the audio/video preferences for the user of the home entertainment network.

### BACKGROUND

High-Definition Multimedia Interface (HDMI) is a compact audio/video interface standard for transmitting and receiving uncompressed digital data. The HDMI standard enables the connection of a digital audio/video source device (e.g., set-top box, Digital Video Disc (DVD) player, camcorder, personal computer, video game console, and audio/video receiver) to a compatible digital audio/video sink device (e.g., computer monitor, video projector, and digital television). The device that sends an HDMI signal (e.g., the DVD player or set-top box) is the HDMI source device, and the device that receives an HDMI signal (e.g., the digital television) is the HDMI sink device.

Digital Visual Interface (DVI) is a video interface standard covering the transmission of video between a source device, such as a personal computer (PC), and a display device. The DVI standard has achieved widespread acceptance in the PC industry, both in desktop PCs and monitors. Most contemporary retail desktop PCs and LCD monitors feature a DVI interface, and many other devices (such as projectors and consumer televisions) support DVI indirectly through HDMI. Many laptops still have legacy Video Graphics Array (VGA) or, in many newer models, HDMI ports, but fewer have DVI ports. DisplayPort is a digital display interface standard that is designed to replace DVI and VGA, as well as replace internal digital low-voltage differential signaling (LVDS) links in computer monitor panels and television panels.

Extended Display Identification Data (EDID), and Enhanced EDID (E-EDID), specify a data structure that a digital display provides to describe its capabilities to a video source (e.g., graphics card or set-top box). EDID and E-EDID enable a modern PC to identify a device that connects to it using information such as the manufacturer name and serial number, product type, phosphor or filter type, timings supported by the display, display size, luminance data, and for digital displays only pixel mapping data. DisplayID is a standard designed to replace EDID and E-EDID. DisplayID will support all existing EDID extensions, as well as support new extensions for 3D displays and embedded displays.

The EDID and E-EDID data structures allow interconnected DVI and HDMI devices to communicate their raw audio/video input and/or output capabilities in an attempt to provide some level of auto-negotiation. EDID and E-EDID works to an extent, but fails to capture a specific user's audio and video preferences within their particular home entertainment network.

There is a need for a method and computing device for configuring devices connected to a home entertainment network by bidirectional audio/video interconnections. The presently disclosed invention satisfies this demand.

### SUMMARY

Aspects of the present invention provide a method and computing device for configuring devices connected to a home entertainment network by bidirectional audio/video interconnections. The method selects a profile for a user of a home entertainment network that includes a display device connected to audio/video source devices where the connection to each audio/video device is a bidirectional audio/video connection, and where the display device includes a preferences manager. The method determines audio/video preferences for the user of the home entertainment network, where the audio/video preferences are based on a user-selected configuration of the preferences manager. The method sends the audio/video preferences to each audio/video source device for configuring each audio/video source device based on the audio/video preferences for the user of the home entertainment network.

### BRIEF DESCRIPTION OF THE DRAWINGS

FIG. 1 is a network diagram that illustrates one embodiment of the hardware components of a system that performs the present invention.

FIG. 2 is a block diagram that illustrates, in detail, one embodiment of the hardware components shown in FIG. 1.

FIG. 3 is a flow diagram that illustrates a method according to one embodiment of the present invention.

### DETAILED DESCRIPTION

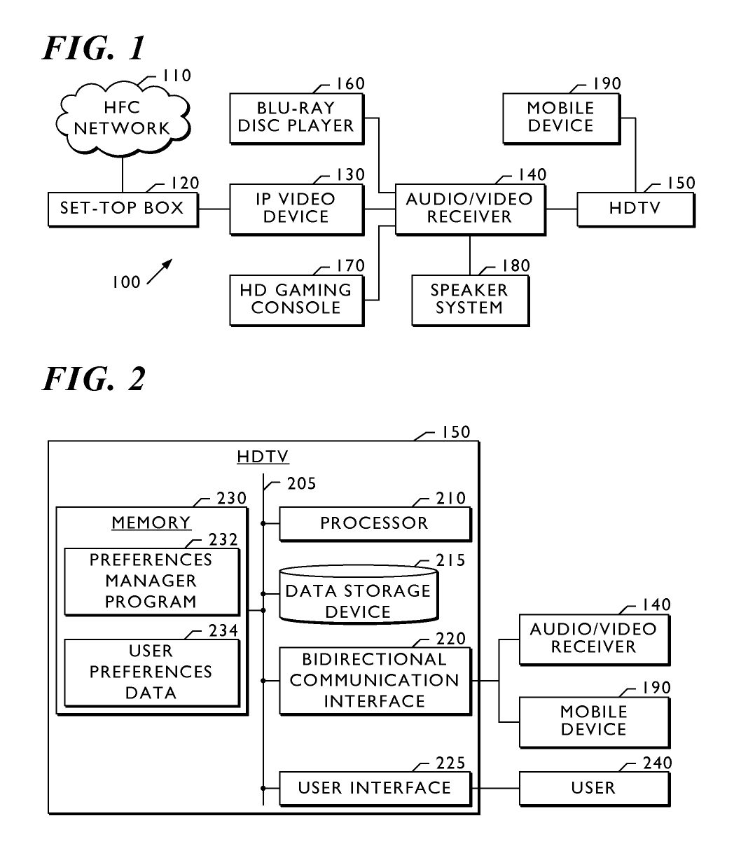

FIG. 1 is a network diagram that illustrates one embodiment of the hardware components of a system that performs the present invention. The home entertainment network 100 shown in FIG. 1 illustrates a complicated, yet increasingly more common, configuration. The home entertainment network 100 includes a hybrid fiber-coaxial (HFC) network 110, set-top box 120, Internet protocol (IP) video device 130, audio/video receiver 140, high-definition television (HDTV) 150, Blu-ray Disc player 160, high-definition (HD) gaming console 170, speaker system 180, and mobile device 190. The home entertainment network 100 shown in FIG. 1 may include any number of set-top box 120, IP video device 130, Blu-ray Disc player 160, HD gaming console 170, and mobile device 190 components. In one embodiment, the connections between the components shown in FIG. 1 are HDMI interconnections. In other embodiments, the connections between the components shown in FIG. 1 are any bidirectional interconnection network that would benefit similarly by the innovation of the present invention.

The HFC network 110 shown in FIG. 1 is a broadband network that combines optical fiber and coaxial cable. The HFC network typically provides two-way communication between a cable operator's headend facility and a subscriber's location. The set-top box 120 receives the communication signals on the downstream communication path, and transmits other communication signals to the headend facility using an upstream communication path.

As shown in FIG. 1, the set-top box 120 is a computing device that connects the components in the home entertainment network 100 to the HFC network 110. In one embodiment, the set-top box 120 is a digital video recorder (DVR) that a cable subscriber operates to request a digital video stream, and store it for viewing at another time on the HDTV 150. In another embodiment, the set-top box 120 connects to an audio/video receiver 140 that forwards the audio signal to a speaker system 180, such as a home theatre system, and forwards the video signal to a display device, such as the HDTV 150. In another embodiment, an IP video device 130, such as a Google TV or Netflix device, connects between the set-top box 120 and the audio/video receiver 140. In other embodiments, the audio/video receiver 140 receives an audio/video signal from the Blu-ray Disc player 160, and the HD gaming console 170. In yet another embodiment, a mobile device 190, such as a smartphone or tablet either with or without a docking station, connects either directly to the HDTV 150 or indirectly via the audio/video receiver 140.

The set-top box 120, IP video device 130, Blu-ray Disc player 160, HD gaming console 170, and mobile device 190 shown in FIG. 1 are audio/video source devices that display video content on the HDTV 150 via the audio/video receiver 140 and render audio content via the audio/video receiver 140 and the speaker system 180. In prior art systems, each component in the home entertainment network 100 had its own audio and video settings menu. Thus, anytime a new video source was added to the prior art home entertainment network 100, the new video source needed to be configured separately to interoperate with the HDTV 150 and deliver the viewing experience desired by the user. Also, in the case of a device such as the set-top box 120 connected through the IP video device 130, the set-top box 120 needed to be configured to interoperate with the IP video device 130, and then the IP video device needed to be configured to interoperate with the HDTV 150. Multiple device configurations will lead to multiple points of failure and add to the user's frustration when adding or upgrading devices on the home entertainment network 100. With digital bidirectional interconnections becoming the norm, there is no need for each device to have its own configuration settings. The one device that is common to all of the devices, the HDTV 150, provides a single “user preferences” screen that is then communicated using the bidirectional interconnections to the various source devices in a true “plug-and-play” fashion. The term “HDTV,” as used herein, is not limited to a display device compliant with a particular HDTV standard or having a particular resolution, and an embodiment is intended to include, for example, digital display devices such as displays, monitors, and projectors supporting audio/video display technology such as high-definition television, 3D TV, Ultra HDTV, 4K video, and the like.

FIG. 2 is a block diagram that illustrates, in detail, one embodiment of the hardware components shown in FIG. 1. In particular, FIG. 2 illustrates the hardware components and software comprising the HDTV 150 shown in FIG. 1.

The HDTV 150, in one embodiment, comprises a general-purpose computing device that performs aspects of the present invention. A bus 205 is a communication medium that connects a processor 210, data storage device 215 (such as a Serial ATA (SATA) hard disk drive, optical drive, Small Computer System Interface (SCSI) disk, flash memory, or the like), bidirectional communication interface 220, user interface 225, and memory 230 (such as Random Access Memory (RAM), Dynamic RAM (DRAM), non-volatile computer memory, flash memory, cloud storage, or the like). The bidirectional communication interface 220, a communication interface that supports interface standards such HDMI, DVI, DisplayPort, or the like, connects the HDTV 150 to an audio/video source device such as the audio/video receiver 140, or the mobile device 190. The user interface 225 connects a user 240 to the HDTV 150. In one embodiment, the user interface 225 is an infrared remote control that enables the user 240 to access an on-screen menu displayed on the HDTV 150. In another embodiment, the user interface 225 is a touchscreen, keypad, or keyboard that enables the user 240 to interact with the HDTV 150. In one embodiment, the implementation of the present invention on the HDTV 150 is an application-specific integrated circuit (ASIC).

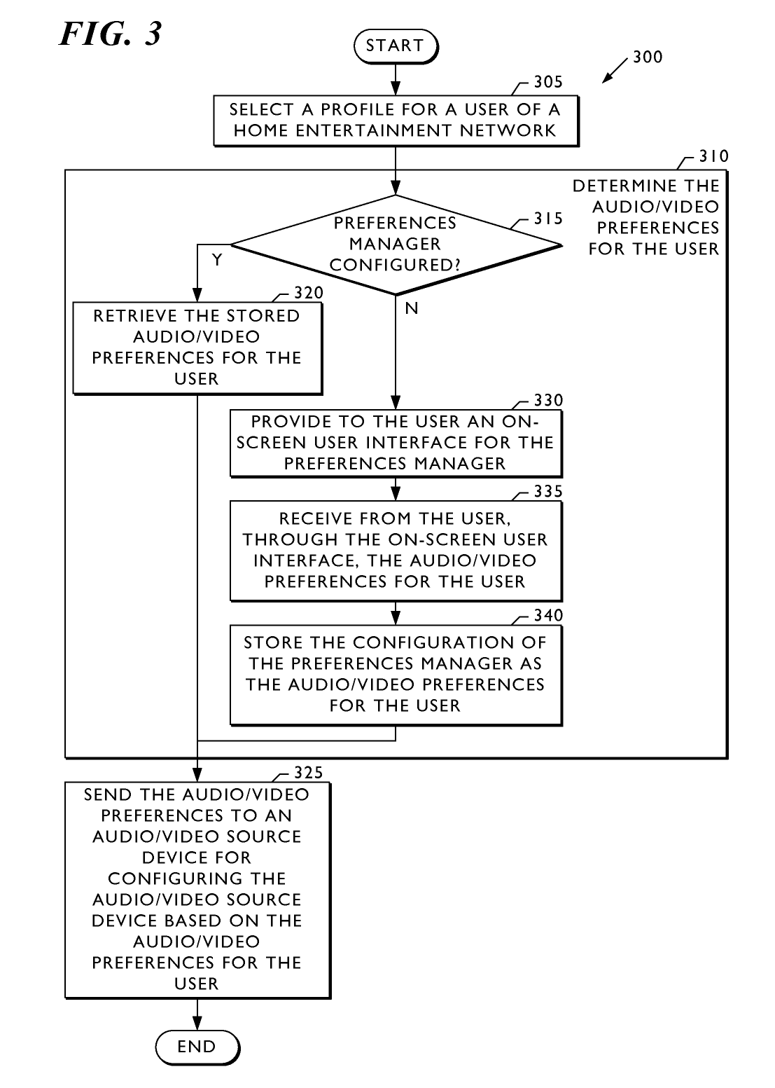

The processor 210 performs the disclosed methods by executing the sequences of operational instructions that comprise each computer program resident in, or operative on, the memory 230. The reader should understand that the memory 230 may include operating system, administrative, and database programs that support the programs disclosed in this application. In one embodiment, the configuration of the memory 230 of the HDTV 150 includes a preferences manager program 232 that performs the method of the present invention disclosed in detail in FIG. 3, and user preferences data 234. When the processor 210 performs the disclosed methods, it stores intermediate results in the memory 230 or data storage device 215. In another embodiment, the processor 210 may swap programs, or portions thereof, in and out of the memory 230 as needed, and thus may include fewer than all of these programs at any one time.

FIG. 3 is a flow diagram that illustrates a method according to one embodiment of the present invention. The process 300 shown in FIG. 3 begins when a profile for the user 240 of a home entertainment network is selected; for example, the profile is selected based upon input from a user 240 who interacts with the user interface 225 of the HDTV 150 to select a profile (step 305). In one embodiment, the user 240 operates a wireless device, e.g., a radio frequency (RF) remote control, or a mobile device running a remote control application, to select a profile for the user 240 from an on-screen menu displayed on the HDTV 150. In another embodiment, the user 240 may also provide security information, such as a password, to confirm his identify. In a further embodiment, the HDTV 150 includes or is communicatively coupled to a device for recognizing the identity of the user 240 (e.g., by use of face recognition, biometrics, 3D imaging and/or motion sensing, detection of a mobile device carried by the user 240, and the like), and is able to select a profile for the user 240 based upon recognizing the identity of the user 240.

As shown in FIG. 3, once the profile for the user 240 of the home entertainment network 100 is selected (step 305), the process 300 determines the audio/video preferences for the user 240 of the home entertainment network 100 (step 310). The process 300 determines whether the user 240 has configured the preferences manager (step 315). If the user 240 has not configured the preferences manager (step 315, N branch), the process 300 provides to the user 240 an on-screen user interface menu for the preferences manager (step 330), receives from the user 240, through the on-screen user interface, the audio/video preferences for the user 240 (step 335), and stores the configuration of the preferences manager as the audio/video preferences for the user 240 (step 340). If the user 240 has already configured the preferences manager (step 315, Y branch), the process 300 retrieves the stored audio/video preferences for the user 240 (step 320). Once the process 300 determines the audio/video preferences for the user 240 on the home entertainment network 100 (step 310), the process 300 sends the audio/video preferences for the user to one of the audio/video source devices for configuring the audio/video source device based on the audio/video preferences for the user 240 (step 325).

For example, one on-screen user interface menu option may allow the user 240 to determine the manner in which to display 4:3 aspect ratio video on a 16:9 widescreen television. There are two primary options available: (A) display the 4:3 video in its native aspect ratio by adding sidebars to the left and right of the video (also known as pillarboxing); or (B) stretch the 4:3 video horizontally to fill the 16:9 screen. Viewer preferences tend to be consistent—if he dislikes sidebars (pillarboxing) around his video content, he would choose to have every device in his entertainment network stretch video to fill a widescreen display. The viewer sets his preference on the television on-screen user interface menu, in this case we will assume he chooses option B, and this preference is shared with all of the upstream source devices. As a result, every interconnected product would then be configured to stretch 4:3 video to a 16:9 frame when necessary, resulting in a consistent entertainment experience for the viewer without the unnecessary frustration of configuring each device individually. There are numerous audio and video settings that could be categorized as “standard” audio/video settings on most source devices today, and therefore this idea would greatly simplify and enhance the experience for users as their home entertainment networks become more diverse and complicated.

The present invention relies on the HDTV 150 in a home entertainment network 100 as a preferences manager, and allows a user 240 to use the on-screen menu for the preferences manager to centralize the configuration of the audio/video preferences for the user 240 on any HDMI device on the home entertainment network 100. The user 240 selects his audio/video preferences in one logical location, the HDTV 150 where all of the content is ultimately viewed, and the HDMI preferences manager program 232 uses the audio/video preferences for the user 240 to automate the configuration of the other HDMI devices on the home entertainment network 100. The present invention is applicable to not only HDMI devices, but also any home entertainment product or audio/video source device outfitted with a digital bidirectional audio/video interface. The most likely home would be future editions of the most popular digital interconnects, namely HDMI and DisplayPort.

In addition, the HDMI preferences manager of the present invention, the HDTV 150, can store preferences for several different user profiles based on their specific needs in the HDTV 150 (e.g., the user preferences data 232). For example, user “Grandmom” has configured a profile that enables closed captioning, and user “Billy” has configured a profile that disables closed captioning. When Grandmom selects her profile on the HDTV 150, the HDTV 150 displays closed captioning whenever it is present in the source content delivered to the HDTV 150. When Billy selects his profile on the HDTV 150 later, the HDTV 150 does not display closed captioning. By selecting their profile on the HDTV 150, Grandmom and Billy automate the configuration of the HDTV 150, and any other HDMI device on the home entertainment network 100 (e.g., the Blu-ray Disc player 160, IP video device 130, HD gaming console 170, or mobile device 190), thereby making the configuration of HDMI devices on the home entertainment network 100 more efficient, and improving the user experience.

The present invention uses the bidirectional communicative properties of most modern digital audio-video interconnections (DVI, HDMI, DisplayPort, etc). The present invention provides a system that allows a viewer to enter their audio/video preferences in one location, regardless of the size and complexity of the home entertainment network, and have each audio/video device connected to the home entertainment network automatically configure itself to provide audio and video in the manner desired by the user. The most logical place for this centralized preferences menu to reside on the endmost downstream device (the final sink) which is the display device, i.e., the television. The television provides an on-screen graphical user interface (GUI) that provides a number of standard audio and video formatting options for the user to configure according to his own personal preferences.

The present invention automates the configuration, and optimizes the audio and video performance, of HDMI devices configured as a chain of interconnected HDMI devices. The basis of HDMI, and DVI before it, is an EDID data structure that allows HDMI devices to communicate their raw audio and video capabilities to each other. However, the functionality of EDID stops there. Even though one HDMI device knows the audio and video formats supported by another HDMI device, there is no linkage to the most important aspect of the entire entertainment system, namely the end user. The present invention describes a plug-and-play configuration approach for interconnected home entertainment devices to receive a master list of the viewer's audio and video preferences from a common location—the endmost sink device of any entertainment system—the television. Any time a new device is interconnected to the home entertainment network, it immediately receives the listing of audio/video preferences for the user from the preferences manager (the television) so that its audio and video output can be automatically configured to match the viewer's preferences without any further intervention required. There is no mechanism in place today for this kind of “set once and forget” preferences structure among interconnected consumer electronics (CE) devices today.

Each audio/video source device in the home entertainment network 100 is capable of determining which audio/video preferences stored on and communicated by the end device (i.e., the HDTV 150) are applicable to it. In this way, an embodiment of the present invention is significantly different from standard EDID functionality in that EDID is only a reporting of raw capabilities, but an embodiment of the present invention is able to capture the user's preferences in one location (the final downstream device, namely, the HDTV 150) and is able to report these viewing preferences to each upstream device using the bidirectional communicative properties of the digital interconnection. Additionally, any new device connected to the entertainment network will be forwarded the master list of viewer preferences and be able to configure itself automatically without any further input required from the user, thereby creating a true home entertainment plug-and-play system using a wide variety of source devices.

Although the disclosed embodiments describe a fully functioning method and computing device for configuring devices connected to a home entertainment network by bidirectional audio/video interconnections, the reader should understand that other equivalent embodiments exist. Since numerous modifications and variations will occur to those reviewing this disclosure, the method and computing device for configuring devices connected to a home entertainment network by bidirectional audio/video interconnections is not limited to the exact construction and operation illustrated and disclosed. Accordingly, this disclosure intends all suitable modifications and equivalents to fall within the scope of the claims.

We claim:

1. A method, comprising:
selecting a profile for a user of a home entertainment network that includes a display device connected to at least one audio/video source device, wherein the connection to each audio/video source device is a bidirectional audio/video connection, and wherein the display device comprises a preferences manager;
determining audio/video preferences for the user of the home entertainment network, wherein the audio/video preferences are based on a user-selected configuration of the preferences manager; and
sending the audio/video preferences to one of the audio/video source devices for configuring the one of the audio/video source devices based on the audio/video preferences for the user of the home entertainment network.

2. The method of claim 1, wherein the bidirectional audio/video connection comprises an interface for at least one of high-definition multimedia interface (HDMI), digital visual interface (DVI), and DisplayPort.

3. The method of claim 1, wherein the display device comprises a high-definition television (HDTV).

4. The method of claim 1, wherein the determining of the audio/video preferences further comprises:
providing to the user an on-screen user interface for the preferences manager;
receiving from the user, through the on-screen user interface, the configuration of the preferences manager; and
storing the configuration of the preferences manager as the audio/video preferences for the user of the home entertainment network.

5. The method of claim 1, wherein the determining of the audio/video preferences further comprises:
retrieving a stored configuration of the preferences manager, the stored configuration corresponding to the audio/video preferences for the user of the home entertainment network.

6. The method of claim 5, wherein the retrieving of the audio/video preferences is from the display device.

7. The method of claim 1, wherein the audio/video preferences comprise at least one of extended display identification data (EDID), Enhanced EDID (E-EDID), and DisplayID for the preferences manager.

8. A display device, comprising:
a memory device resident in the display device; and
a processor disposed in communication with the memory device, the processor configured to:
select a profile for a user of a home entertainment network that includes the display device connected to at least one audio/video source device, wherein the connection to each audio/video source device is a bidirectional audio/video connection, and wherein the display device comprises a preferences manager;
determine audio/video preferences for the user of the home entertainment network, wherein the audio/video preferences are based on a user-selected configuration of the preferences manager; and
send the audio/video preferences to one of the audio/video source devices for configuring the one of the audio/video source devices based on the audio/video preferences for the user of the home entertainment network.

9. The display device of claim 8, wherein the bidirectional audio/video connection comprises an interface for at least one of high-definition multimedia interface (HDMI), digital visual interface (DVI), and DisplayPort.

10. The display device of claim 8, wherein the display device comprises a high-definition television (HDTV).

11. The display device of claim 8, wherein to determine the audio/video preferences, the processor is further configured to:
provide to the user an on-screen user interface for the preferences manager;
receive from the user, through the on-screen user interface, the configuration of the preferences manager; and
store the configuration of the preferences manager as the audio/video preferences for the user of the home entertainment network.

12. The display device of claim 8, wherein to determine the audio/video preferences, the processor is further configured to:
retrieve a stored configuration of the preferences manager, the stored configuration corresponding to the audio/video preferences for the user of the home entertainment network.

13. The display device of claim 12, wherein the retrieving of the audio/video preferences is from the display device.

14. The display device of claim 8, wherein the audio/video preferences comprise at least one of extended display identification data (EDID), Enhanced EDID (E-EDID), and DisplayID for the preferences manager.

15. An audio/video source device, comprising:
a bidirectional audio/video interface for connecting the audio/video source device to a display device, wherein a home entertainment network comprises the display device and the audio/video source device, and wherein the display device comprises a preferences manager;
a memory device resident in the audio/video source device;
a processor disposed in communication with the memory device, the processor configured to:
receive audio/video preferences for a user of the home entertainment network, wherein the audio/video preferences are based on a user-selected configuration of the preferences manager; and
configure the audio/video source device based on the audio/video preferences for the user of the home entertainment network.

16. The audio/video source device of claim 15, wherein the bidirectional audio/video interface comprises at least one of high-definition multimedia interface (HDMI), digital video interface (DVI), and DisplayPort.

17. The audio/video source device of claim 15, wherein the preferences manager determines the audio/video preferences for the user of the home entertainment network.

18. The audio/video source device of claim 15, wherein the display device comprises a high-definition television (HDTV).

19. The audio/video source device of claim 15, wherein the user-selected configuration of the preferences manager is through an on-screen user interface.

20. The audio/video source device of claim 15, wherein the audio/video preferences comprise at least one of extended display identification data (EDID), Enhanced EDID (E-EDID), and DisplayID for the preferences manager.
